(19) United States
(12) Patent Application Publication
(10) Pub. No.: US 2024/0408767 A1
(43) Pub. Date: Dec. 12, 2024

(54) CONTROL DEVICE

(71) Applicant: FANUC CORPORATION, Yamanashi (JP)

(72) Inventors: Yuutarou TAKAHASHI, Yamanashi (JP); Yuta NAMIKI, Yamanashi (JP)

(21) Appl. No.: 18/716,930

(22) PCT Filed: Jan. 25, 2022
(86) PCT No.: PCT/JP2022/002707

§ 371 Date: Jun. 6, 2024

(51) Int. Cl. B25J 9/16

(52) U.S. Cl. CPC B25J 9/1697; B25J 9/1653; B25J 9/1661

(57) ABSTRACT

A control device includes: a detection result acquisition unit which acquires first information corresponding to a detection result obtained through detecting, by means of a visual sensor, the relative positional relationship between a robot and an object; a coordinate system data output unit which, on the basis of the first information, outputs first coordinate system data as data representing a coordinate system that serve as the basis when operating the robot; and a command generation unit which generates a command for the robot on the basis of the first coordinate system represented by the first coordinate system data.

### FIELD

The present invention relates to a control device of a robot.

### BACKGROUND

A control device that allows a user to carry out programming using an icon representing a function constituting a control program of a robot in order to intuitively teach a control program to the robot has been proposed (for example, PTL 1). A robot system for performing picking up of bulk workpieces and the like in which an image of a workpiece is captured by a visual sensor mounted on a robot and the robot operates to grasp an appropriate position of the workpiece and arrange the workpiece at a desired position is also known (for example, PTL 2).

### CITATION LIST

### Patent Literature

[PTL 1] PCT International Publication No. WO2020/012558 A1
[PTL 2] Japanese Unexamined Patent Publication (Kokai) No. 2018-144166 A

### SUMMARY

### Technical Problem

In a robot system for performing work on a workpiece, a relative positional relationship between the workpiece and a robot may change due to a shift of a position of the workpiece from an expected position, and the like. In order to create, on a user side, a control program for appropriately performing handling of the workpiece while correcting a position of the robot in such a case, the user is required to have a high degree of knowledge for programming such as a data format of positional data obtained as a detection result by a visual sensor and a data format of coordinate system data. Thus, it is generally difficult to carry out, on a user side, programming for achieving such correction of a position of a robot. A control device configured to allow a user to use a function of achieving such correction of a position of a robot in an easier way is desired.

### Solution to Problem

One aspect of the present disclosure is a control device including: a detection result acquisition unit configured to acquire first information corresponding to a detection result of detecting a relative positional relationship between a robot and a target object by a visual sensor; a coordinate system data output unit configured to output, based on the first information, first coordinate system data as data representing a coordinate system based on which a robot performs motion; and an instruction generation unit configured to generate an instruction to the robot base on a first coordinate system represented by the first coordinate system data.

A different aspect of the present disclosure is a control device including: an instruction generation unit configured to generate an instruction to a robot by using a first coordinate system as a coordinate system based on which the robot performs motion; a detection result acquisition unit configured to acquire first information corresponding to a detection result of detecting a relative positional relationship between the robot and a target object by a visual sensor; and a coordinate system shift unit configured to shift the first coordinate system, based on the first information.

### Advantageous Effects of Invention

When a relative positional relationship between a robot and a target object changes, the configuration described above can allow a user to use a function of correcting a position of the robot based on a detection result by a visual sensor in an easier way for a user to handle.

The objects, the features, and the advantages, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating an overall configuration of a robot system including a control device according to a first embodiment.

FIG. 2 is a diagram illustrating a hardware configuration example of a robot controller and a teaching operation device.

FIG. 3 is a block diagram illustrating a functional configuration of the control device according to the first embodiment.

FIG. 4 is a diagram illustrating an example of a program creation screen created by a screen display creation unit.

FIG. 5 is a diagram illustrating an example of a control program according to the first embodiment.

FIG. 6 is a diagram illustrating a setting screen for carrying out detailed setting of a “user coordinate system setting” icon.

FIG. 7 is a diagram illustrating a setting screen for carrying out teaching on a “pickup/arrange” icon.

FIG. 8 is a diagram illustrating a setting screen for carrying out teaching on a hand close icon.

FIG. 9 is a block diagram illustrating a functional configuration of a control device according to a second embodiment.

FIG. 10 is a diagram illustrating an example of a control program according to the second embodiment.

FIG. 11 is a diagram illustrating a setting screen for carrying out detailed setting of a “user coordinate system setting (shift)” icon.

FIG. 12 is an apparatus configuration diagram of a robot system according to a third embodiment.

FIG. 13 is a block diagram illustrating a functional configuration of a control device according to the third embodiment.

FIG. 14 is a diagram illustrating an arrangement of markers on a table.

FIG. 15 is a flowchart illustrating instruction generation processing.

FIG. 16 is a flowchart illustrating user coordinate system shift processing.

### DESCRIPTION OF EMBODIMENTS

Next, embodiments of the present disclosure will be described with reference to drawings. A similar configuration portion or a similar functional portion is denoted by the same reference sign in the referred drawings. A scale is appropriately changed in the drawings in order to facilitate understanding. An aspect illustrated in the drawing is one example for implementing the present invention, and the present invention is not limited to the illustrated aspect.

### First Embodiment

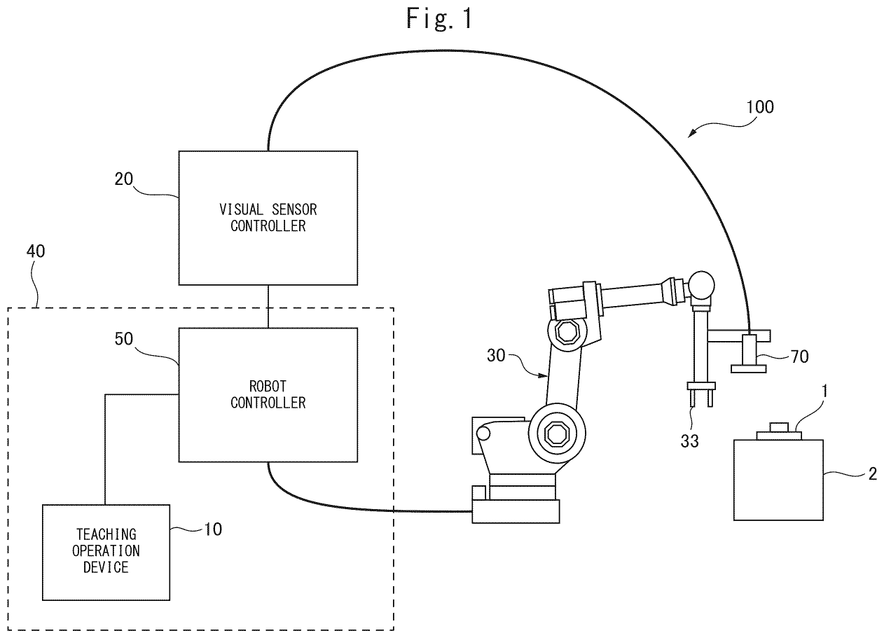

FIG. 1 is a diagram illustrating an overall configuration of a robot system 100 including a control device 40 according to a first embodiment. In the present embodiment, the functions provided by a robot controller 50 and a teaching operation device 10 constitute the control device 40 for controlling a robot 30. The control device 40 is a device that allows a user to carry out programming using an icon representing a function constituting a control program of the robot 30 (i.e., representing a command of robot control). Various configuration examples are possible as a robot system including such a control device 40, but, in the present embodiment, the robot system 100 illustrated in FIG. 1 is described as an exemplification. The robot system 100 includes the robot 30 including a hand 33 mounted on an arm tip portion, the robot controller 50 that controls the robot 30, the teaching operation device 10 connected to the robot controller 50, a visual sensor 70 attached to the arm tip portion of the robot 30, and a visual sensor controller 20 that controls the visual sensor 70. The visual sensor 70 is connected to the robot controller 50.

The robot 30 is a vertical articulated robot in the present example, but a robot of another type may be used. The teaching operation device 10 is used as a device for performing an operation input and a screen display for teaching the operation to the robot 30 (i.e., creating a control program). As the teaching operation device 10, a tablet teaching operation device, a teach pendant, or an information processing device, such as a personal computer (PC), provided with the teaching function may be used.

The visual sensor controller 20 has a function of controlling the visual sensor 70 and a function of performing image processing on an image captured by the visual sensor 70. The visual sensor controller 20 can detect a position of a target object (hereinafter also described as a workpiece) 1 placed on a worktable 2 from the image captured by the visual sensor 70, record a detection result, and provide the position of the workpiece 1 as the detection result to the robot controller 50. In this way, the robot 30 (robot controller 50) can correct a teaching position, and appropriately perform work such as picking-up of the workpiece 1.

The visual sensor 70 may be a camera that captures a gray-scale image and a color image, or may be a stereo camera or a three-dimensional sensor that can acquire a distance image and a three-dimensional point group. In the robot system 100, a plurality of visual sensors may be disposed. The visual sensor controller 20 holds a model pattern of a target object, and performs image processing of detecting a target object by matching between an image of the target object in a captured image and the model pattern. It is assumed that calibration has been performed on the visual sensor 70 and the visual sensor controller 20 has calibration data. Thus, in the control device 40 (robot controller 50), a relative positional relationship between the robot 30 and the visual sensor 70 is already known.

It should be noted that, in FIG. 1, the visual sensor controller 20 is formed as a device provided separately from the robot controller 50, but the function as the visual sensor controller 20 may be embedded in the robot controller 50.

In such a robot system 100, for example, a relative positional relationship between the workpiece 1 and the robot 30 may change due to a shift of the workpiece 1 from a reference position. By using a detection function by the visual sensor 70, the control device 40 provides a function capable of appropriately handling the workpiece 1 also in such a case as a function in a form that can be used in an easy way for a user to handle.

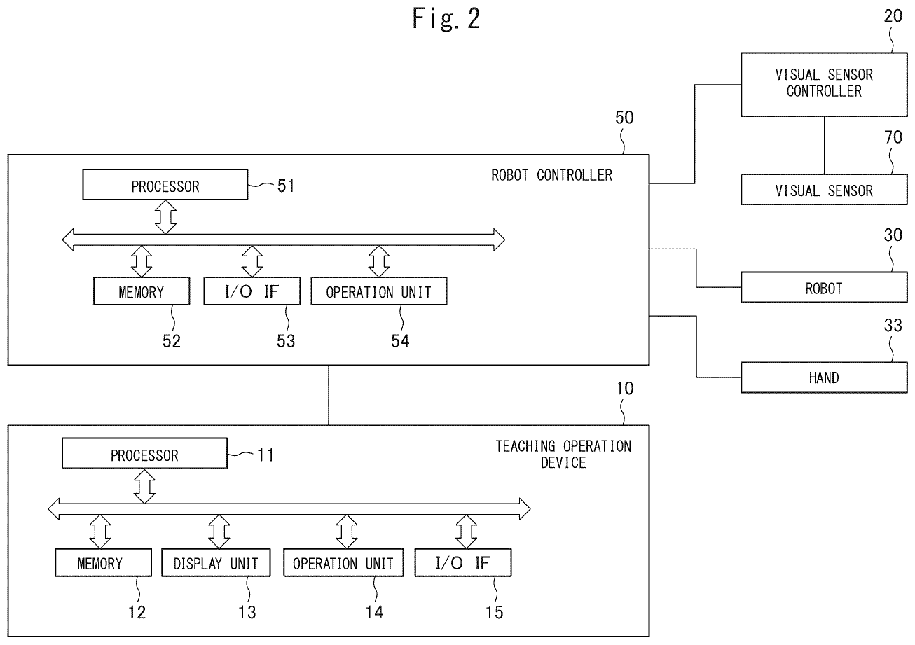

FIG. 2 is a diagram illustrating a hardware configuration example of the robot controller 50 and the teaching operation device 10. The robot controller 50 may have a configuration as a general computer in which a memory 52 (such as a ROM, a RAM, and a non-volatile memory), an input/output interface 53, an operation unit 54 including various operation switches, and the like are connected to a processor 51 via a bus. The teaching operation device 10 may have a configuration as a general computer in which a memory 12 (such as a ROM, a RAM, and a non-volatile memory), a display unit 13, an operation unit 14 formed of an input device such as a keyboard (or a software key), an input/output interface 15, and the like are connected to a processor 11 via a bus.

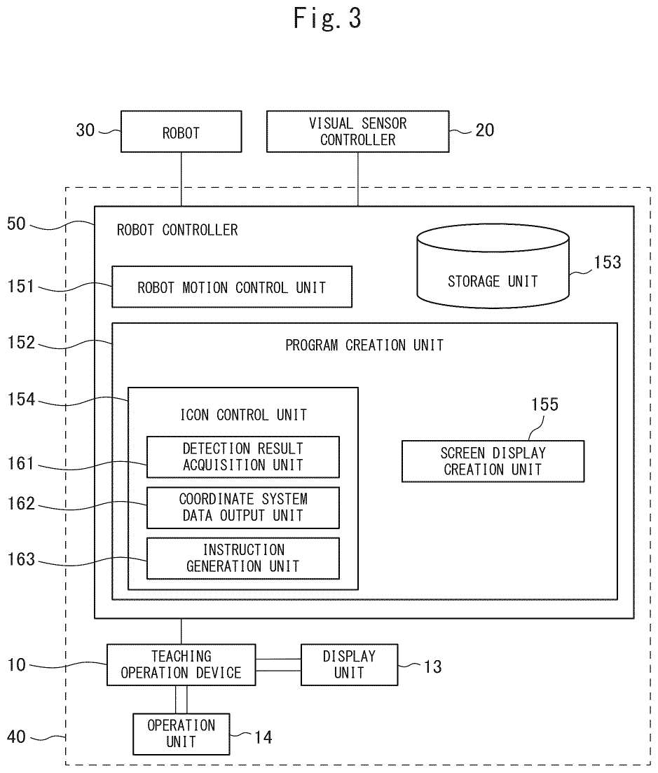

FIG. 3 is a block diagram illustrating a functional configuration of the control device 40 formed of the robot controller 50 and the teaching operation device 10. The function as the control device 40 illustrated in FIG. 3 may be achieved by executing various types of software stored in a storage device by the processor of the robot controller 50 or the teaching operation device 10, or may be achieved by a configuration in which hardware such as an application specific integrated circuit (ASIC) is a main body.

As illustrated in FIG. 3, the robot controller 50 includes a robot motion control unit 151, a program creation unit 152, and a storage unit 153.

The robot motion control unit 151 controls motion of the robot 30 according to a control program or an instruction from the teaching operation device 10. In other words, the robot motion control unit 151 generates a trajectory plan of a predetermined control portion (for example, a tool center point (TCP)) of the robot 30 according to a control program or an instruction from the teaching operation device, and also generates an instruction of each axis of the robot 30 by kinematic calculation. Then, the robot motion control unit 151 moves the predetermined control portion of the robot 30 according to the planned trajectory by performing servo control on each axis according to the instruction of each axis.

The storage unit 153 stores a control program and various types of setting information related to teaching. The storage unit 153 may be formed of, for example, a non-volatile memory in the memory 52. The information related to teaching includes setting information about a coordinate system, and information about an icon (such as data about a shape (image) of each icon, and a setting parameter).

The program creation unit 152 provides, via a user interface (a display unit 13 and an operation unit 14) of the teaching operation device 10, various functions for a user to carry out programming using a command sentence on a text basis or an icon. The program creation unit 152 includes an icon control unit 154 and a screen display creation unit 155 as components that provide such functions.

The screen display creation unit 155 provides functions of presenting various interface screens used when programming is carried out, and receiving a user input. Various user interface screens may be formed as a touch panel operation screen on which a touch operation can be carried out.

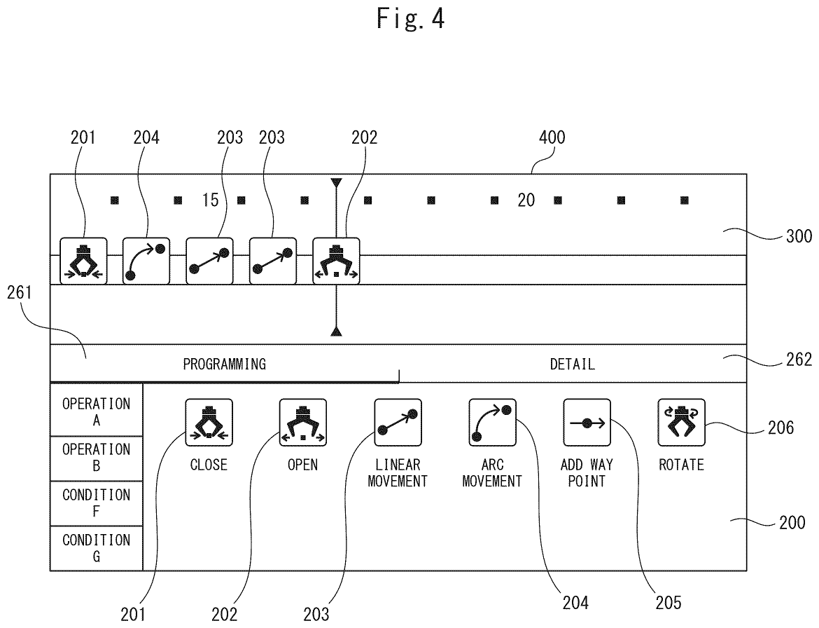

FIG. 4 illustrates an example of a program creation screen 400 created by the screen display creation unit 155 and displayed on the display unit 13 of the teaching operation device 10. As illustrated in FIG. 4, the program creation screen 400 includes an icon display region 200 for displaying a list of various icons that can be used for programming, and a program creation region 300 for creating a control program by disposing the icons in order. It should be noted that the program creation region 300 is a region where an icon is disposed in a time series of execution, and may thus be referred to as a time line. In the example in FIG. 4, the icon display region 200 includes a hand close icon 201 representing a command for closing a hand, a hand open icon 202 representing a command for opening the hand, a linear movement icon 203, an arc movement icon 204, a way point addition icon 205, and a rotation icon 206 representing a command for rotating the hand.

A user can select an icon by, for example, putting a cursor on the icon. The user carries out programming by selecting a desired icon from the icon display region 200 and disposing the icon in the program creation region 300, for example, by a drag-and-drop operation.

On the program creation screen 400, the user selects a programming tab 261 when the user carries out programming. By selecting an icon in the program creation region 300 and selecting a detail tab 262, the user can open a setting screen for carrying out detailed setting (parameter setting) of the icon. Further, the user can execute a control program by carrying out a predetermined operation in a state where icons are arranged in the program creation region 300.

The icon control unit 154 has the functions of setting the function of an icon and supporting various user operations on an icon. Under support by the icon control unit 154, the user can carry out detailed setting of a function of an icon, and create a control program by selecting a desired icon from a list of icons disposed in the icon display region 200 and arranging the icon in the program creation region 300.

Herein, a coordinate system set in a control device of a robot will be described. Various coordinate systems can be set in the control device of the robot, and include a coordinate system unique to the robot and a coordinate system that can be set by a user. The coordinate system unique to the robot includes a world coordinate system set at a position (for example, a base of the robot) not changed by a posture of the robot, a face plate coordinate system set on a face plate surface of an arm tip forming a mechanical interface of the robot, and the like. The coordinate system that can be set by a user includes a workpiece coordinate system set on a workpiece and the like in such a way as to have a specific relationship with a position and a posture of the workpiece being a work target. The workpiece coordinate system is a coordinate system that is set by applying at least one of translation and rotation to the world coordinate system. The coordinate system that can be set by a user includes a tool coordinate system that expresses a position and a posture of a tool tip point with reference to the face plate coordinate system. A user can specify any of these coordinate systems as a coordinate system based on which the robot performs motion.

It should be noted that, in particular, the workpiece coordinate system or the tool coordinate system that can be set by a user among the coordinate systems is set as a coordinate system used by the control device, and thus an operation of teaching work on a target object to the robot (such as a jog operation using X, Y, and Z-axis direction keys of a teaching operation device) can be smoothly carried out. It should be noted that, in the present specification, the coordinate system that can be set by a user may be referred to as a user coordinate system. An example of a data format of coordinate system data set by a user is indicated as follows. The present example is the workpiece coordinate system, and expresses a position and a posture of the workpiece coordinate system with reference to the world coordinate system (X, Y, and Z represent a three-dimensional position, and W, P, and R respectively represent rotation about an X-axis, a Y-axis, and a Z-axis).

User coordinate system UF1:
X=180.000 mm Y=0.000 mm Z=180.000 mm
W=180.000 deg P=0.000 deg R=−90.000 deg

The icon control unit 154 includes a detection result acquisition unit 161, a coordinate system data output unit 162, and an instruction generation unit 163.

The detection result acquisition unit 161 acquires information indicating a detection result of detecting a relative positional relationship between the robot 30 and the workpiece 1 by the visual sensor 70. Specifically, the detection result acquisition unit 161 functions as a positional data acquisition unit that extracts positional data as a detection result selected by a user from a special storage destination. The coordinate system data output unit 162 outputs, based on the information acquired by the detection result acquisition unit 161, coordinate system data indicating a coordinate system based on which the robot 30 performs motion. The instruction generation unit 163 generates a motion instruction (various motion instructions such as a linear movement, an arc movement, and workpiece extraction) of the robot according to a content taught by the user.

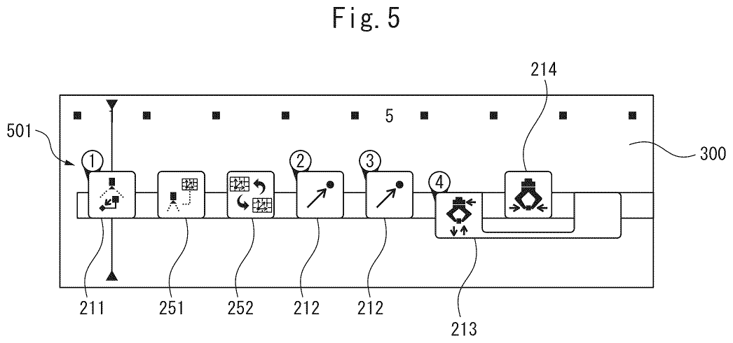

In the present embodiment, the icon control unit 154 provides, as a function implemented on an icon, a function as the detection result acquisition unit 161 and the coordinate system data output unit 162. As the icon related to such a function, a “user coordinate system setting” icon 251 and a “user coordinate system selection” icon 252 are provided (see FIG. 5). The “user coordinate system setting” icon 251 is provided with the function as the detection result acquisition unit 161 and the coordinate system data output unit 162. The “user coordinate system selection” icon 252 provides a function of switching a coordinate system based on which the robot 30 operates to a coordinate system output by the “user coordinate system setting” icon 251 (in another expression, switching a user coordinate system).

FIG. 5 illustrates a control program 501 as one example of a control program using such “user coordinate system setting” icon 251 and “user coordinate system selection” icon 252. The control program 501 includes a “view” icon 211 corresponding to a command of the detection function by the visual sensor 70, the “user coordinate system setting” icon 251, the “user coordinate system selection” icon 252, two linear movement icons 212, a “pickup/arrange” icon 213 for motion of picking up or arranging a workpiece, and a hand close icon 214 as one function of workpiece extraction motion.

The “view” icon 211 provides a function of detecting a workpiece by the visual sensor and outputting a detection result including positional data about the detected workpiece. The positional data about the workpiece as the detection result indicate, as one example, a detected position of the workpiece in a coordinate system set in the view icon. The detected position is used together with the coordinate system by the “user coordinate system setting” icon 251.

The linear movement icon 212 provides a function of linearly moving a predetermined movable portion (for example, a TCP) of a robot. The “pickup/arrange” icon 213 provides a function of picking up a workpiece by using a function of the hand close icon 214 included in a range of the “pickup/arrange” icon 213. The hand close icon 214 corresponds to a command for closing a hand and holding a workpiece.

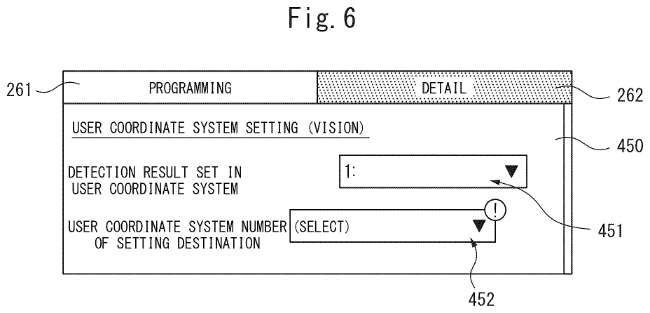

FIG. 6 is a diagram illustrating a setting screen 450 for carrying out detailed setting (teaching) of the “user coordinate system setting” icon 251. As one example, the setting screen 450 can be activated by selecting the “user coordinate system setting” icon 251 on the program creation region 300 illustrated in FIG. 5 and selecting the detail tab 262. The setting screen 450 includes a selection field 451 for selecting a “detection result set in a user coordinate system”, and a specification field 452 for specifying a “user coordinate system number of a setting destination”.

The selection field 451 of a detection result is a field for selecting a detection result which a user wants to use, from among detection results acquired by performing the operation of detecting a target object by the visual sensor. A drop-down list that displays a list of detection results can be displayed by operating a triangular mark of the selection field 451, and data about a desired detection result can be selected from the list. A detection result is stored in a specific storage destination (for example, the memory of the visual sensor controller 20, the memory of the robot controller 50, an external memory, and the like). In the present embodiment, it is assumed that a detection result is stored in a vision resistor as an internal resistor of the robot controller 50. Therefore, for example, the user may specify a resistor number of the vision resistor in which a detection result of a workpiece by the “view” icon 211 is stored. Alternatively, a detection result may be specified by directly specifying the “view” icon 211 that outputs the detection result, or the like.

The specification field 452 of a user coordinate system number is a field for specifying the number of a user coordinate system to which coordinate system data corresponding to positional data extracted from the detection result selected in the selection field 451 of a detection result is output. A drop-down list that displays a list of user coordinate systems (UF1, UF2, UF3 . . . ) can be displayed by operating a triangular mark of the specification field 452, and a user coordinate system of a desired number can be selected from the list. In this way, the positional data are extracted from the detection result selected in the selection field 451, and are output as the coordinate system data about the user coordinate system specified in the specification field 452.

The operation procedures of a function implemented on the “user coordinate system setting” icon 251 will be described with an example. It is assumed that the number of a vision resistor selected in the selection field 451 of a detection result is a vision resistor 01, and the number of a user coordinate system specified in the specification field 452 of a user coordinate system number is UF1. The vision resistor 01 is assumed to indicate a detected position P1 (three-dimensional position) of a workpiece acquired by the view icon 251. The detected position P1 is assumed to be a position on the coordinate system UF1 set for the view icon 251.

(Procedure 1) The detection result acquisition unit 161 extracts the detected position P1 from the vision resistor 01.
(Procedure 2) The coordinate system data output unit 162 converts the detected position P1 to a position P1′ in a world coordinate system of a robot by the following equation (1).

P1′=UF1·P1 (1)

Herein, UF1 represents an origin position of UF1 viewed from the world coordinate system and is expressed in a homogeneous transformation matrix.
(Procedure 3) The coordinate system data output unit 162 enters a value of P1′ as it is into the user coordinate system specified in the specification field 452. In this way, the user coordinate system specified in the specification field 452 is set as a coordinate system in which P1′ viewed from the world coordinate system is the origin.

By the operation described above, coordinate system data that express positional data as a detection result selected by a user can be output as a user coordinate system of which the number is specified by the user.

Teaching procedures for teaching the control program 501 to a robot in the present embodiment are as follows.

(Procedure T1) Settings of each of the “view” icon 211 and the “user coordinate system setting” icon 251 is taught by a user to the control device.
(Procedure T2) By executing each of the “view” icon 211 and the “user coordinate system setting” icon 251, a value of coordinate system data is entered into a user coordinate system specified by the “user coordinate system setting” icon 251.
(Procedure T3) The “user coordinate system selection” icon 252 is executed in that state, and a coordinate system based on which a robot operates is switched to the user coordinate system into which the value is entered in the procedure T2.
(Procedure T4) Subsequently, settings of each motion icon (the linear movement icon 212 and the “pickup/arrange” icon 213) is taught by the user to the control device 40.

At the stage of the teaching in the procedure (T4) described above, the user coordinate system used by the user has already converted to a coordinate system according to the detected position of a workpiece, and thus the user can carry out teaching of the robot without the need to carry out an operation for applying a correction value.

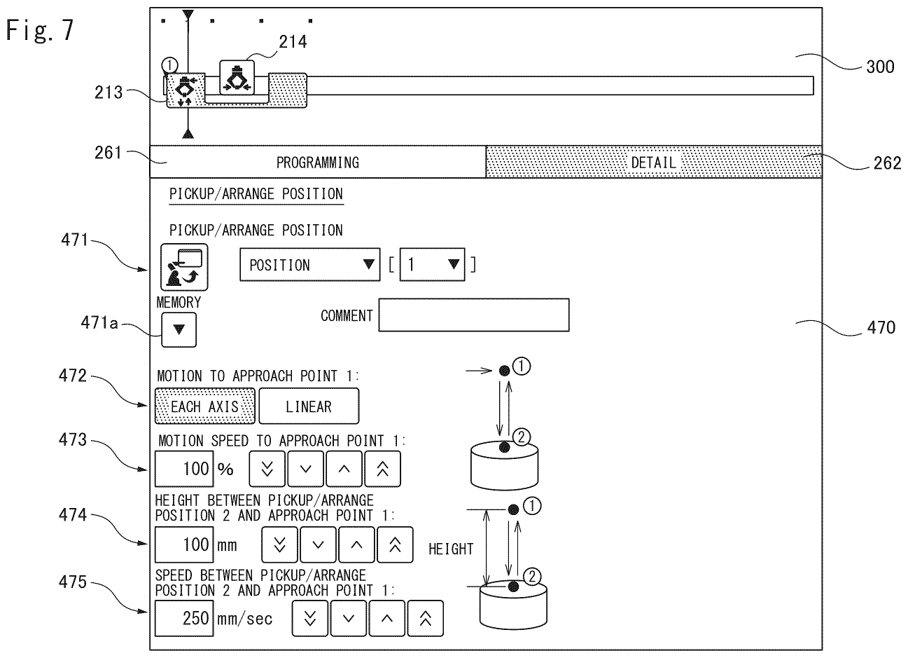

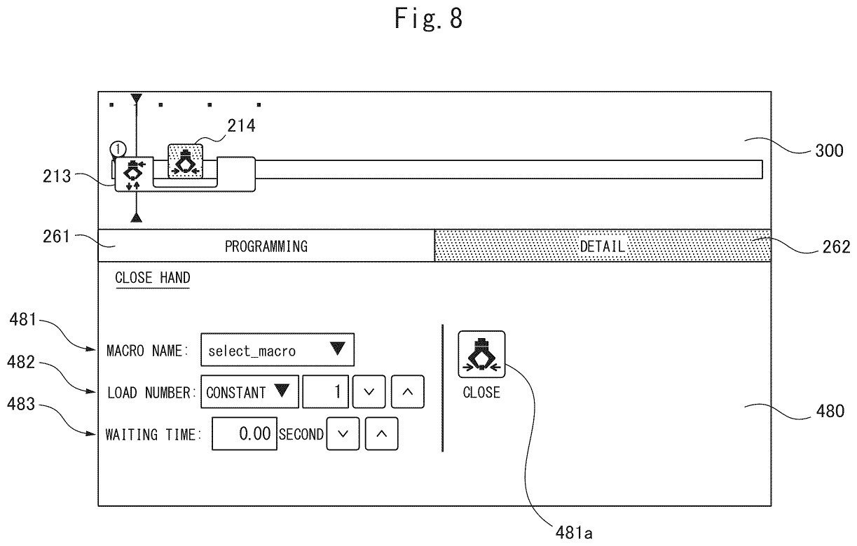

A setting screen 470 when teaching is carried out on the “pickup/arrange” icon 213 and a setting screen 480 when teaching is carried out on the hand close icon 214 in the teaching procedure T4 described above are illustrated in FIGS. 7 and 8, respectively. As illustrated in FIG. 7, the setting screen 470 of the “pickup/arrange” icon 213 includes a specification field 471 for teaching a pickup/arrange position to a robot, a specification field 472 for specifying motion (each axis motion or linear motion) to an approach point with respect to a workpiece, a specification field 473 for specifying a motion speed to the approach point, a specification field 474 for specifying a height between the pickup/arrange position and the approach point, and a specification field 475 for specifying a motion speed between the pickup/arrange position and the approach point. The user can teach the “pickup/arrange position” for picking up or arranging the workpiece to the robot 30 by moving the robot 30 to a desired position for holding the workpiece by a jog operation and the like, and pressing a memory button 471a. At this stage, a coordinate system based on which the robot 30 operates has already been set as a coordinate system with the detected position P1′ of the workpiece as the origin, and thus the user does not need to carry out setting and the like for applying a detected position (corrected position) at the stage of teaching of the “pickup/arrange” icon 213.

As illustrated in FIG. 8, the setting screen 480 of the hand close icon 214 includes a field 481 for specifying a name of a macro command for closing a hand, a specification field 482 for specifying load information being switched according to a workpiece, and a specification field 483 for specifying a waiting time during motion of closing the hand. The motion of closing the hand can be executed by pressing a close button 481a located on the right side.

In this way, according to the present embodiment, only by carrying out, on the “user coordinate system setting” icon 251, a simple operation of selecting a detection result desired to be used and specifying the number of a user coordinate system desired to output coordinate system data, a user can output coordinate system data based on the detection result as coordinate system data of the specified user coordinate system. The user does not need to individually carry out correction based on the detection result on each icon (such as the linear movement icon and the pickup/arrange icon).

According to the present embodiment, a coordinate system setting function can be added, by a simple way, to various detection techniques of a target object (such as a position detection technique of a target object by the “view” icon, and a position detection technique of a target object by measuring a marker (for example, measurement of a relative positional relationship between a robot and a target object by measuring positions of three points of markers)) being provided based on a visual detection function. Also, when a user desires to set a coordinate system, based on a detection result by the existing visual detection function, the user may add the “user coordinate system setting” icon described above to the existing visual detection function (such as the “view” icon) without the need to learn a new way. Further, according to the present embodiment, a correction method of a position of a robot based on a detection result by the visual detection function can be easily switched to a correction method by using a coordinate system. In other words, in a normal correction method an operation of correcting a motion command icon needs to be carried out by using positional data (correction amount) being output as a detection result by the “view” icon; however, according to the present embodiment, a correction method can be easily switched to a correction method using a coordinate system by operating the “user coordinate system setting” icon.

In this way, when a relative positional relationship between a robot and a target object changes, the present embodiment can provide a function capable of using a function of correcting a position of the robot, based on a detection result by a visual sensor, in an easier way for a user to handle.

### Second Embodiment

Hereinafter, a control device according to a second embodiment will be described. A configuration of a robot system including the control device according to the second embodiment and a hardware configuration are common to the configurations according to the first embodiment illustrated in FIGS. 1 and 2. The control device according to the second embodiment is different from the first embodiment in regard to a function of an icon for providing coordinate system data based on a detection result by a visual sensor, and a robot controller and the control device according to the second embodiment are referred to as a robot controller 50A and a control device 40A, respectively.

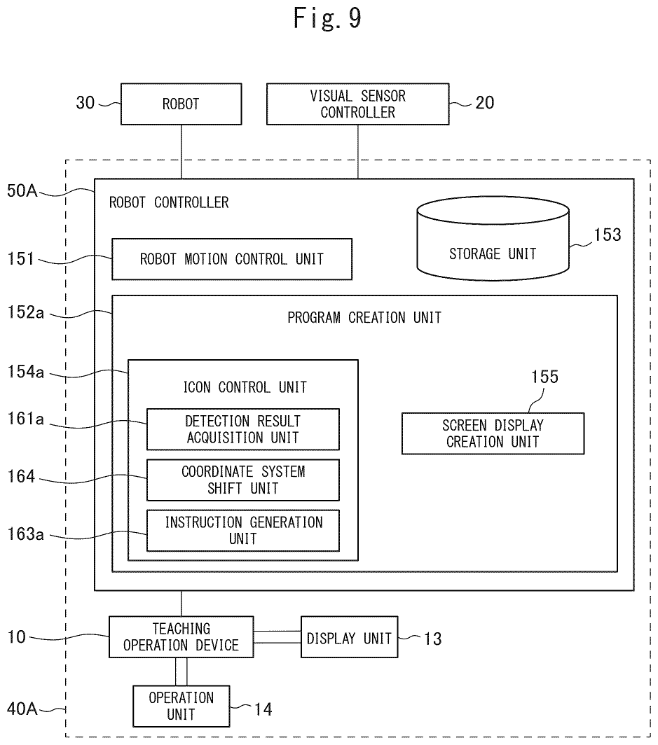

FIG. 9 is a functional block diagram of the control device 40A according to the second embodiment. It should be noted that, in FIG. 9, a functional block common to the control device 40 according to the first embodiment is provided with a common reference sign. The control device 40A is a control device that allows a user to carry out programming using an icon similarly to the control device 40 according to the first embodiment. Similarly to the control device 40 according to the first embodiment, the control device 40A provides, as a function in a form that can be used in an easy way for a user to handle, a function capable of appropriately handling a workpiece 1 also when a relative positional relationship between the workpiece 1 and a robot 30 changes.

As illustrated in FIG. 9, the robot controller 50A includes a robot motion control unit 151, a program creation unit 152a, and a storage unit 153. The program creation unit 152a provides, via a user interface of a teaching operation device 10, various functions for the user to carry out programming using a command sentence on a text basis or an icon.

The program creation unit 152a includes an icon control unit 154a and a screen display creation unit 155. The icon control unit 154a has the functions of setting the function of an icon and supporting various user operations on an icon.

The icon control unit 154a includes a detection result acquisition unit 161a, a coordinate system shift unit 164, and an instruction generation unit 163a.

The instruction generation unit 163a generates an instruction to a robot by using a certain specific coordinate system (for example, a user coordinate system specified by the user) as a coordinate system based on which the robot performs motion. The detection result acquisition unit 161a acquires information indicating a detection result of detecting a relative positional relationship between the robot 30 and the workpiece 1 by a visual sensor 70. Specifically, the detection result acquisition unit 161a functions as a positional data acquisition unit that extracts positional data as a detection result selected by the user from a special storage destination. The coordinate system shift unit 164 shifts the specific coordinate system used in the instruction generation unit 163a, based on the positional data as the detection result.

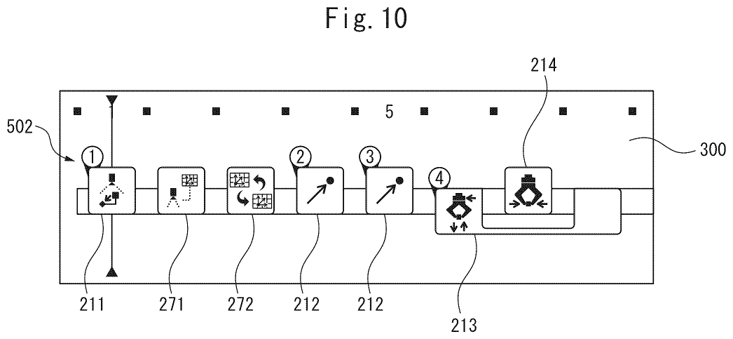

In the present embodiment, the icon control unit 154a provides, as a function implemented on an icon, a function as the detection result acquisition unit 161a and the coordinate system shift unit 164. As the icon related to such a function, a “user coordinate system setting (shift)” icon 271 and a “user coordinate system selection” icon 272 are provided (see FIG. 10). The “user coordinate system setting (shift)” icon 271 is provided with the function as the detection result acquisition unit 161a and the coordinate system shift unit 164. The “user coordinate system selection” icon 272 provides a function of switching a coordinate system based on which the robot 30 operates to a coordinate system shifted by the “user coordinate system setting (shift)” icon 271 (in another expression, switching a user coordinate system).

FIG. 10 illustrates a control program 502 as one example of a control program created by using such “user coordinate system setting (shift)” icon 271 and “user coordinate system selection” icon 272. The control program 502 includes a “view” icon 211 being a command of a detection function by the visual sensor, the “user coordinate system setting (shift)” icon 271, the “user coordinate system selection” icon 272, two linear movement icons 212, a “pickup/arrange” icon 213, and a hand close icon 214 as one function of workpiece picking-up motion.

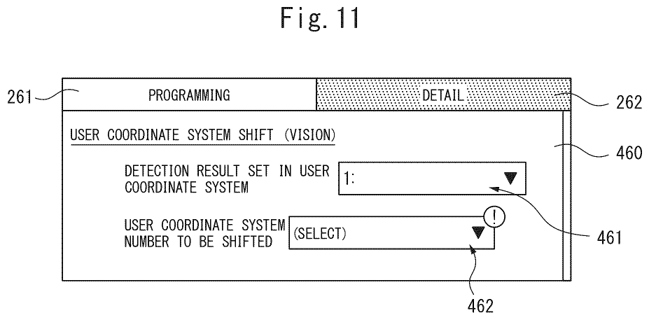

FIG. 11 is a setting screen 460 for carrying out detailed setting (teaching) of the “user coordinate system setting (shift)” icon 271. As one example, the setting screen 460 can be activated by selecting the “user coordinate system setting (shift)” icon 271 on a program creation region 300 illustrated in FIG. 10 and selecting a detail tab 262. The setting screen 460 includes a selection field 461 for selecting a “detection result set in a user coordinate system”, and a specification field 462 for specifying a “user coordinate system number to be shifted”.

The selection field 461 of a detection result is a field for selecting a detection result desired to be used by a user among detection results acquired by performing motion of detecting a target object by the visual sensor (motion of the view icon). A drop-down list that displays a list of detection results can be displayed by operating a triangular mark of the selection column 461, and data about a desired detection result can be selected from the list. A detection result is stored in a specific storage destination. In the present embodiment, it is assumed that a detection result is stored in a vision resistor as an internal resistor of the robot controller 50A. Therefore, for example, the user may specify a resistor number of the vision resistor in which a detection result of a workpiece by the “view” icon 211 is stored. Alternatively, a detection result may be specified by directly specifying the “view” icon 211 that outputs the detection result, or the like.

The specification field 462 of a user coordinate system is a field for specifying the number of a user coordinate system to be shifted by a movement amount corresponding to a correction amount indicated by positional data extracted from the detection result selected in the selection column 461 of a detection result. A drop-down list that displays a list of user coordinate systems (UF1, UF2, UF3 . . . ) can be displayed by operating a triangular mark of the specification column 462, and a user coordinate system of a desired number can be selected from the list.

By operating the “user coordinate system setting (shift) icon” 271 subjected to the setting as described above, the user coordinate system specified in the specification field 462 of a user coordinate system can be shifted by the movement amount corresponding to the correction amount based on the detection result.

The “user coordinate system selection” icon 272 switches a coordinate system based on which a robot operates to a user coordinate system of which the number is specified by the “user coordinate system setting (shift)” icon.

The operation procedures of a function provided to the “user coordinate system setting (shift)” icon 271 will be described with an example. It is assumed that a correction amount (shift amount from a reference position of a workpiece) acquired as a detection result by the “view” icon 211 is O1, and the correction amount O1 is stored in a vision resistor 01. The correction amount O1 is assumed to be a correction amount on the coordinate system UF1 set in the “view” icon 211. It is assumed that a detection result selected in the selection field 461 of a detection result of the “user coordinate system setting (shift)” icon 271 is the vision resistor 01, and a user coordinate system specified in the specification field 462 of a user coordinate system is UF2.

(Procedure 1) The detection result acquisition unit 161a extracts the correction amount O1 from the vision resistor 01.
(Procedure 2) The coordinate system shift unit 164 calculates a coordinate system UF2′ acquired by shifting the coordinate system UF2 according to the correction amount O1 by the following equation (2).

UF2′=UF1·O1·INV(UF1)·UF2 (2)

Herein, UF1 and UF2 represent an origin position of each coordinate system viewed from the world coordinate system and are expressed in a homogeneous transformation matrix. INV (UF1) is an inverse matrix of UF1.

It should be noted that, when UF1=UF2 holds true herein, the equation (2) can be simplified as in the following equation (3).

UF2′=UF1(UF2)·O1 (3)

(Procedure 3) A value of the calculation result UF2′ is substituted as-is in the specified user coordinate system UF2.

As described above, the user coordinate system UF2 is a coordinate system acquired by shifting the user coordinate system UF2 according to the correction amount O1 on the world coordinate system.

Teaching procedures for teaching the control program 502 to a robot in the present embodiment are a manner as follows.

(Procedure T21) A user himself/herself freely sets a coordinate system (UF2). For example, the user may set a workpiece coordinate system having a specific relationship with a position and a posture of a workpiece in a workspace.
(Procedure T22) The user switches a coordinate system based on which a robot operates to the coordinate system UF2 set in the procedure (T21) described above, and carries out teaching of the robot (such as the linear movement icon 212 and the “pickup/arrange” icon 213).
(Procedure T23) Settings of each of the “view” icon 211 and the “user coordinate system setting (shift)” icon 271 is taught by the user to the control device.

In this way, in the present embodiment, a robot is taught in advance on a user coordinate system being freely set by a user himself/herself, and the user coordinate system is specified in the subsequent procedure T23, and thus the user coordinate system is shifted according to a correction amount. In this way, all movements of the robot can be shifted according to the correction amount. In a different expression, it is assumed in the second embodiment unlike the first embodiment that the user sets the user coordinate system UF2 in advance. Thus, in the second embodiment, the procedure is executed by storing a user coordinate system (a value of the user coordinate system UF2 set in the procedure T21) which is subsequently overwritten, and then performing a computation (equation (2) described above) for a shift, based on the user coordinate system.

In this way, according to the present embodiment, the user coordinate system UF2 used when a user teaches the linear movement icon 212 and the “pickup/arrange” icon 213 to a robot in advance is shifted according to a detection result (correction amount), and thus a teaching position being taught in advance is a value on the shifted user coordinate system UF2. Thus, when these icons are executed by a processor of the robot controller, motion of the robot is properly performed on a workpiece located at a detected position. The user does not need to individually carry out correction based on the detection result on each icon (such as the linear movement icon and the pickup/arrange icon).

In this way, when a relative positional relationship between a robot and a target object changes, the present embodiment can provide a function of correcting a position of the robot based on a detection result by a visual sensor, in an easier way for a user to handle.

### Third Embodiment

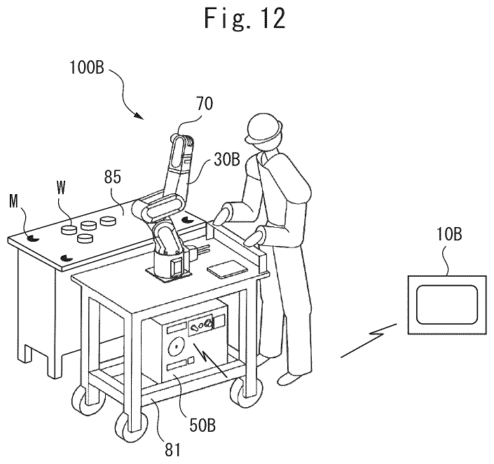

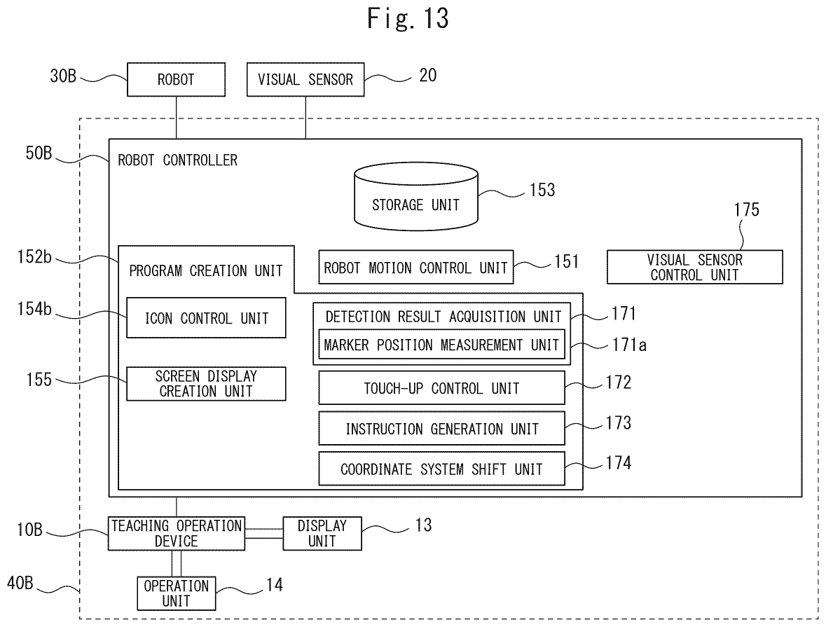

The third embodiment relates to a robot system 100B configured to perform work on a workpiece placed on a table by a robot mounted on a cart. FIG. 12 is an apparatus configuration diagram of the robot system 100B. It should be noted that a hardware configuration of a robot controller 50B and a teaching operation device 10B is similar to FIG. 2. FIG. 13 is a functional block diagram focusing on a function as a control device in the robot system 100B. As illustrated in FIG. 12, the robot system 100B includes a robot 30B mounted on a cart 81, the robot controller 50B that controls the robot 30B, and the teaching operation device 10B connected to the robot controller 50B in a wired or wireless manner. A tool such as a hand (not illustrated in FIG. 12) is attached to a tip portion of the robot 30B. Further, a visual sensor 70 is attached to the tip portion of the robot 30B. A workpiece W is placed on a table 85, and the robot 30B can perform predetermined work such as picking-up of the workpiece W.

A plurality of markers M are stuck to the table 85, and a relative positional relationship between the table 85 and the cart 81 (robot 30B) can be determined by measuring the markers M by the visual sensor 70 mounted on the robot 30B. Since a workpiece is placed at a specific position on the table 85, a position of the workpiece can be specified by a coordinate system set on the table 85. The coordinate system on the table 85 is assumed to be a coordinate system UF1. By specifying a position on the coordinate system UF1 by a numerical value, the robot 30B can be controlled to perform work on the workpiece W without teaching the operation to the robot 30B. However, when absolute accuracy of the robot 30B is not high, an actual movement amount of the robot 30B and a movement amount calculated by the robot 30 may not coincide with each other with sufficient accuracy. In such a case, even when the robot 30B intends to perform work at a position specified by a numerical value, work cannot be performed with sufficient accuracy. In the present embodiment, even in such a situation, the robot 30B can perform work on the workpiece W on the table 85 with excellent accuracy. Similarly to the control device 40A according to the second embodiment, the control device 40B provides, as a function in a form that can be used in an easier way for a user to handle, a function capable of appropriately handling the workpiece W also when a relative positional relationship between the workpiece W and the robot 30B changes.

The function as the control device 40B will be described with reference to the functional block diagram in FIG. 13. It should be noted that, in FIG. 13, a component equivalent to the control device 40 according to the first embodiment is provided with the same reference sign. As illustrated in FIG. 13, the robot controller 50B includes a robot motion control unit 151, a program creation unit 152b, and a storage unit 153. It should be noted that, in the present embodiment, the robot controller 50B includes a visual sensor control unit 175 having the function as the visual sensor controller 20 described above.

The robot motion control unit 151 controls motion of the robot 30B. The storage unit 153 stores a control program and various types of setting information related to teaching. The program creation unit 152b provides, via a user interface (a display unit 13 and an operation unit 14) of the teaching operation device 10B, various functions for a user to carry out programming using an icon. The program creation unit 152b includes an icon control unit 154b and a screen display creation unit 155 as components that provide such functions. The icon control unit 154b supports a user operation when the user operates an icon, a tab, and the like on the program creation screen 400 as illustrated in FIG. 4 via the operation unit 14 of the teaching operation device 10B. The screen display creation unit 155 displays various interface screens used when programming using an icon is carried out, and supports a user operation on the interface screens.

The program creation unit 152b further includes a detection result acquisition unit 171, a touch-up control unit 172, an instruction generation unit 173, and a coordinate system shift unit 174.

The detection result acquisition unit 171 includes a marker position measurement unit 171a, and the marker position measurement unit 171a has a function of measuring a three-dimensional position of the marker M by using the visual sensor 70. It should be noted that, it is assumed that calibration has been performed on the visual sensor 70 (i.e., the visual sensor control unit 175 has calibration data), and a position and a posture of the visual sensor 70 with reference to the robot 30B are already known. As one example, the marker position measurement unit 171a may measure a three-dimensional position of the marker M by a stereo measurement method by using the visual sensor 70 as a two-dimensional camera. It should be noted that various measurement techniques known in the art may be used by using various markers known in the art for measuring a position, which are also referred to as a target mark and a visual marker.

The touch-up control unit 172 controls touch-up motion of touching a target point by a predetermined position control portion (for example, a TCP) of the robot 30B, and acquiring positional information about the target point.

The instruction generation unit 173 provides a function of generating a movement instruction of a robot, based on positional information acquired by touch-up.

The coordinate system shift unit 174 provides a function of shifting a user coordinate system by using a detection function of the visual sensor 70. In the present embodiment, an example of operation of shifting, by using a detection result by the visual sensor 70, a coordinate system (user coordinate system) set by touch-up will be described.

The control device 40B according to the present embodiment can provide
(F1) a function of correcting a movement instruction of a robot being set based on positional information acquired by touching up a predetermined position on a table by using known positional information about the predetermined position on the table, and
(F2) a function of shifting a user coordinate system by using positional information acquired by capturing the predetermined position on the table by the visual sensor before and after a change in a relative position between the robot and the table.
   By using the instruction acquired by the function (F1) described above on the shifted coordinate system acquired by the function (F2) described above, the robot can be controlled to perform work on a workpiece with a high degree of precision even after the change in the relative position between the table and the robot.

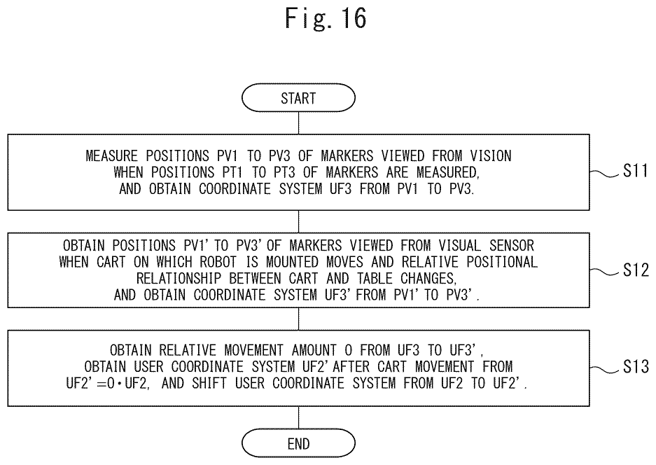

A flowchart representing instruction generation processing corresponding to the function (F1) described above is illustrated in FIG. 15, and a flowchart representing user coordinate system shift processing corresponding to the function (F2) described above is illustrated in FIG. 16. These pieces of processing may be performed as continuous processing. These pieces of processing are performed under control of a processor of the robot controller 50B.

(FIG. 15: step S1)

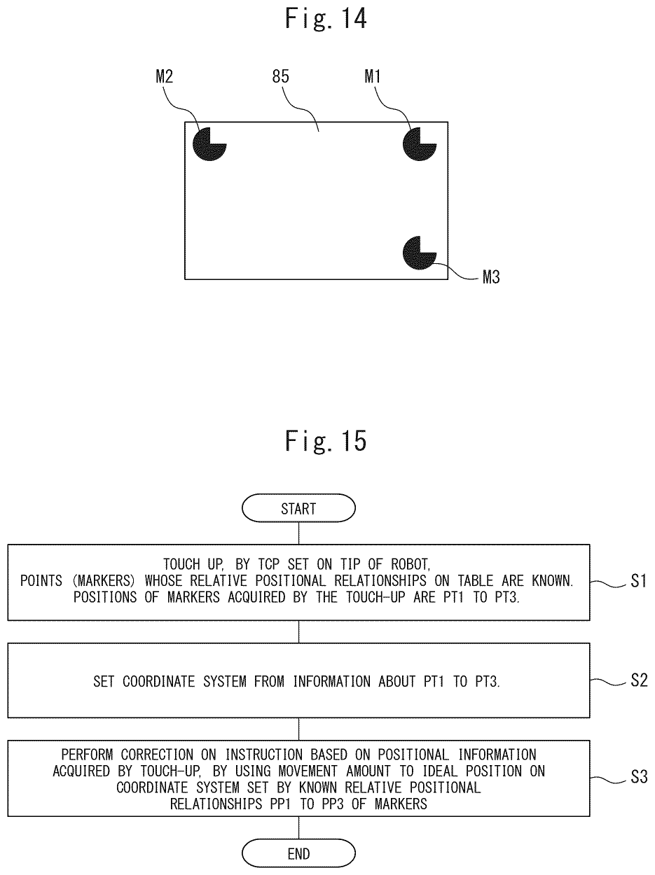

A plurality of points whose relative positional relationships on the table 85 are known are touched up by a TCP set on a tip of the robot 30B. Herein, it is assumed that positions of markers M1 to M3 are touched up as known positions on the table 85. FIG. 14 illustrates an arrangement of the markers M1, M2, and M3. The positions (three-dimensional vectors) of the three markers M1 to M3 acquired by the touch-up motion are assumed to be PT1 to PT3. Known relative positional relationships among the three markers are assumed to be PPI to PP3. PP1 to PP3 are assumed to be positional information having sufficiently high accuracy. The positions PP1 to PP3 are assumed to be stored in the storage unit 153, for example. A coordinate system UF1 is assumed to be a coordinate system defined on the table 85, based on the positions PPI to PP3.

(FIG. 15: step S2)

A coordinate system UF2 is set from the information about the PT1 to PT3. Setting of a coordinate system using PT1 to PT3 is performed as follows, for example. Herein, it is assumed that PT1 to PT3 (i.e., the marker M1 to the marker M3) are located on the same plane. In this case, a plane defined by PT1 to PT3 is defined as an XY plane, and an axis line direction from PT1 (marker M1) to PT2 (marker M2) is defined as an X-axis direction. In this way, an axis line vertical to the X-axis can also be defined as a Y-axis, and a Z-axis can also be defined as an axis line vertical to the XY plane. It should be noted that the origin of the coordinate system UF2 and a direction of each coordinate axis can be defined in such a way as to match those in the coordinate system UF1. In an ideal state where absolute accuracy of a robot is high, the coordinate system UF1 and the coordinate system UF2 coincide with each other. However, as described above, in a situation where absolute accuracy of a robot is not high, a position of the robot calculated by the robot and an actual position of the robot are different, and thus the coordinate system UF1 and the coordinate system UF2 do not coincide with each other.

(FIG. 15: step S3)

An ideal position on the table 85 is converted to a position on the coordinate system UF2. Herein, as an exemplification, such conversion is performed by the following technique. As an exemplification, it is assumed that the marker M1, the marker M2, and the marker M3 are disposed in such a way as to respectively represent an origin position, a position in the X-axis direction, and a position in the Y-axis direction, and PP1, PP2, and PP3 respectively represent the origin position, the position in the X-axis direction, and the position in the Y-axis direction. x and y when an ideal position PI on the table 85 is expressed by the following equation (4) using PPI to PP3 are obtained.

PI=x(PP2−PP1)+y(PP3−PP1) (4)

Next, an instruction position P_PT for moving the robot to the ideal position PI is obtained by the following equation (5) by using PT1 to PT3.

P_PT=x(PT2−PT1)+y(PT3−PT1) (5)

x and y define an ideal position calculated in the coordinate system by the accurate coordinate values PP1 to PP3. On the other hand, the positions PT1 to PT3 calculated by the robot 30B may not coincide with PPI to PP3 when considered as the coordinate values, but may coincide with the respective markers M1 to M3 with excellent accuracy when consider as actual TCP positions of the robot 30B. Therefore, even when an instruction to move the robot 30B to the instruction position P_PT acquired by applying x and y to the equation (2) described above is an instruction on the coordinate system UF2, the robot 30B can be moved to a correct position.

It should be noted that, P_PT is defined as a value of a coordinate system in which PT1 to PT3 are measured, and is thus converted to a position P_UF2 on the coordinate system UF2. By providing, to the robot 30B, an instruction to switch to the coordinate system UF2 (set a coordinate system based on which the robot 30B operates, to UF2) and move to the position P_UF2, an accuracy error described above of the robot 30B can be absorbed, and the robot 30B can be controlled to move to the ideal position and to perform work.

The processing in steps S1 and S2 of the processing in steps S1 to S3 described above can be achieved as operation by the touch-up control unit 172. Further, the processing in step S3 can be achieved as operation by the instruction generation unit 173.

The processing in step S3 can be expressed as operation of generating an instruction to the robot 30B, based on the positional information PP1 to PP3 about a predetermined position of a target object (table 85) and the positional information PT1 to PT3 acquired by touching up the predetermined position of the target object (table 85) by the robot 30B. In other words, the processing in step S3 is processing of obtaining a movement amount on the coordinate system defined by the positional information PPI to PP3, and applying the movement amount as a movement amount in the coordinate system UF2 (coordinate system corresponding to the coordinate system defined by the positional information PT1 to PT3).

Next, a specific processing content of the function (F2) described above will be described with reference to FIG. 16. Herein, as an exemplification, in a situation where the cart 81 moves and a relative positional relationship between the cart 81 on which the robot 30B is mounted and the table 85 changes, a user coordinate system is shifted by using a detection result by the visual sensor 70.

(FIG. 16: step S11)

Positions PV1 to PV3 of the markers M1 to M3 viewed from the visual sensor 70 are measured. Measurement of the positions of the markers M1 to M3 viewed from the visual sensor 70 can be performed by the marker position measurement unit 171a. Then, a coordinate system UF3 is obtained from PV1 to PV3. The technique described above can be used for setting a coordinate system based on the measurement positions PV1 to PV3 of the markers M1 to M3.

(FIG. 16: step S12)

Herein, it is assumed that the cart 81 moves and a positional relationship between the cart 81 (i.e., the robot 30B) and the table 85 changes. At this time, positions PV1′ to PV3′ viewed from the visual sensor 70 are measured. Then, a coordinate system UF3′ is obtained from PV1′ to PV3′.

(FIG. 16: step S13)

A relative movement amount O from UF3 to UF3′ can be calculated by

O=UF3′·INV(UF3)

Herein, INV ( ) represents calculation of an inverse matrix, and UF3′ and UF3 are expressed in a homogeneous transformation matrix.
The coordinate system UF2′ being the coordinate system UF2 after movement of the cart 81 can be obtained from

UF2′=O·UF2

By providing, to the robot 30B, an instruction to move to the position P_UF2 on shifted UF2′, an accuracy error described above of the robot 30B can be absorbed, and the robot 30B can be moved to the ideal position and controlled to perform work.

The function provided by steps S11 to S13 described above can be expressed as a function of allowing a robot to continue motion by shifting a user coordinate system, based on a detection result of the visual sensor, when the cart 81 moves. In this way, the function of shifting a user coordinate system can also be achieved as a function by one icon. For example, the function may be provided as an icon having an appearance like the “user coordinate system setting (shift)” icon 271 as illustrated in FIG. 8. As detailed setting of the “user coordinate system setting (shift)” icon in this case, a configuration provided with a selection field for selecting a detection result of a marker by the visual sensor and a specification field for specifying the number of a user coordinate system to be shifted can be used.

In this way, according to the present embodiment, when a relative positional relationship between a robot and a target object changes, a function of correcting a position of the robot, based on a detection result by a visual sensor, can be used in an easier way for a user to handle.

The present invention has been described above by using the typical embodiments, but it will be understood by those of ordinary skill in the art that changes, other various changes, omission, and addition may be made in each of the embodiments described above without departing from the scope of the present invention.

Arrangement of the functional blocks illustrated in the functional block diagram in each of the embodiments described above is one example, and one or more functional blocks disposed in the robot controller may be disposed in the teaching operation device.

The function of the “user coordinate system selection” icon 252 indicated in the first embodiment may be integrated with the “user coordinate system setting” icon 251. The function of the “user coordinate system selection” icon 272 indicated in the second embodiment may be integrated with the “user coordinate system setting (shift)” icon 271.

The program for executing various pieces of processing such as the instruction generation processing and the user coordinate system shift processing in the embodiments described above can be recorded in various computer-readable recording media (for example, a ROM, an EEPROM, a semiconductor memory such as a flash memory, a magnetic recording medium, and an optical disk such as a CD-ROM and a DVD-ROM).

### REFERENCE SIGNS LIST

1, W Workpiece
2 Worktable
10, 10B Teaching operation device
11 Processor
12 Memory
13 Display unit
14 Operation unit
15 Input/output interface
20 Visual sensor controller
30, 30B Robot
33 Hand
40, 40A Control device
50, 50A Robot controller
51 Processor
52 Memory
53 Input/output interface
54 Operation unit
70 Visual sensor
100, 100B Robot system
151 Robot motion control unit
152, 152a, 152b Program creation unit
153 Storage unit
154, 154a, 154b Icon control unit
155 Screen display creation unit
161, 161a Detection result acquisition unit
162 Coordinate system data output unit
163, 163a Instruction generation unit
164 Coordinate system shift unit
171 Detection result acquisition unit
171a Marker position measurement unit
172 Touch-up control unit
173 Instruction generation unit
174 Coordinate system shift unit
200 Icon display region
251 “User coordinate system setting” icon
252, 272 “User coordinate system selection” icon
261 Programming tab
262 Detail tab
271 “User coordinate system setting (shift)” icon
300 Program creation region
400 Program creation screen

1. A control device comprising:
a detection result acquisition unit configured to acquire first information corresponding to a detection result of detecting a relative positional relationship between a robot and a target object by a visual sensor;
a coordinate system data output unit configured to output, based on the first information, first coordinate system data as data representing a coordinate system based on which the robot performs motion; and
an instruction generation unit configured to generate an instruction to the robot based on a first coordinate system represented by the first coordinate system data.

2. The control device according to claim 1, wherein
the detection result acquisition unit acquires the first information indicating a detection result selected by a user input among one or more of detection results stored in a predetermined storage destination.

3. The control device according to claim 1, further comprising
an icon control unit configured to provide, as a function implemented on an icon representing a function constituting a control program of a robot, a function as the detection result acquisition unit and the coordinate system data output unit.

4. The control device according to claim 1, wherein
the first information indicates a detected position of the target object on a second coordinate system having a specific relationship with a world coordinate system, and
the coordinate system data output unit outputs the first coordinate system data, based on second coordinate system data representing the second coordinate system, and the detected position.

5. A control device comprising:
an instruction generation unit configured to generate an instruction to a robot by using a first coordinate system as a coordinate system based on which the robot performs motion;
a detection result acquisition unit configured to acquire first information corresponding to a detection result of detecting a relative positional relationship between the robot and a target object by a visual sensor; and
a coordinate system shift unit configured to shift the first coordinate system, based on the first information.

6. The control device according to claim 5, wherein
the detection result acquisition unit acquires the first information indicating a detection result selected by a user input among one or more of detection results stored in a predetermined storage destination.

7. The control device according to claim 5, further comprising
an icon control unit configured to provide, as a function implemented on an icon representing a function constituting a control program of a robot, a function as the detection result acquisition unit and the coordinate system shift unit.

8. The control device according to claim 5, wherein
the first information indicates a correction amount of a position of the target object on a second coordinate system having a specific relationship with a world coordinate system, and
the coordinate system shift unit obtains shifted first coordinate system data as a result of shifting the first coordinate system, based on second coordinate system data representing the second coordinate system, the correction amount, and first coordinate system data representing the first coordinate system.

9. The control device according to claim 5, further comprising:
a storage unit configured to store positional information about a predetermined position of the target object; and
a touch-up control unit configured to acquire second information indicating the predetermined position of the target object by touching up the predetermined position of the target object by the robot, wherein
the instruction generation unit generates the instruction, based on the positional information stored in the storage unit and the second information.

10. The control device according to claim 9, wherein
the instruction generation unit generates the instruction by obtaining a movement amount to a specific position of the robot on a coordinate system defined by the positional information stored in the storage unit, and applying the obtained movement amount as a movement amount in the first coordinate system.

11. The control device according to claim 9, wherein
the touch-up control unit causes a TCP of the robot to touch up the predetermined position of the target object.

12. The control device according to claim 9, wherein
the detection result acquisition unit obtains the first information as a relative movement amount between the target object and the robot by measuring the predetermined position of the target object by the visual sensor mounted on the robot before and after a relative positional relationship between the target object and the robot changes.

13. The control device according to claim 12, wherein
the coordinate system shift unit shifts the first coordinate system, based on the relative movement amount.
